(19) United States
(12) Patent Application Publication
(10) Pub. No.: US 2014/0333761 A1
(43) Pub. Date: Nov. 13, 2014

(54) AUTOMATED ITEM RETURN MACHINES

(71) Applicant: Amazon Technologies, Inc., (US)

(72) Inventor: Richard Franklin Porter, Seattle, WA (US)

(73) Assignee: Amazon Technologies, Inc., Reno, NV (US)

(21) Appl. No.: 13/889,622

(22) Filed: May 8, 2013

(51) Int. Cl. G06Q 30/06; G06K 9/00

(52) U.S. Cl. CPC G06Q 30/06; G06K 9/00624
USPC 348/135; 705/7.35

(57) ABSTRACT

Automated return machines may receive items to be returned to an electronic marketplace by a customer, or repurchased by the electronic marketplace, within one or more designated chambers. The machines may gather one or more attributes of the item and utilize such attributes to confirm an identity of the item or to evaluate its condition, and to generate an offer for the repurchase of the item based on an anticipated demand for the item as well as a strategy or plan to distribute the item, either directly from the automated return machine or from a facility designated by an electronic marketplace. If the offer is declined, the item may be returned to the customer. If the offer is accepted, a credit for the item may be remitted to the customer, and the item may be added to the inventory at the electronic marketplace and made available for resale to other customers.

### BACKGROUND

Electronic marketplaces provide forums where customers may purchase a variety of items (including goods, services, products, information or media of any type or form) through one or more portals that may be accessible through the Internet, such as network sites or other electronic interfaces. When a customer places an order for an item from an electronic marketplace, the item may be delivered to the customer in any corner of the globe, and by any known transportation means, including ground, sea or air transit.

Occasionally, a customer who purchases an item from an electronic marketplace may wish to return the item to the marketplace for any number of reasons. For example, the customer may ultimately determine that the item is unnecessary, or that the item does not fit the customer's particular needs. Additionally, when a customer purchases an item outright and uses the item in a manner that is consistent with the purpose for which it was intended, but no longer requires the item, the customer may attempt to sell the item back to the marketplace. For example, where a customer purchases and reads a book from an electronic marketplace, but no longer needs or desires to own the book, the customer may attempt to sell the book back to the marketplace in a used condition.

Presently, a number of physical and virtual constraints complicate the return or repurchase of items, such as books, from customers by an electronic marketplace. For example, negotiating the terms of a repurchase agreement may be complicated when one of the parties is a human and another of the parties is represented by an electronic interface, or when a significant physical distance separates the parties. While a customer who purchases an item from a bricks-and-mortar merchant is usually able to return to the merchant in person, and enable the merchant to evaluate the condition and/or demand for the item, or to prepare an appropriate offer for the item at a market price, customers are unable to engage in such a free-flowing negotiation with an electronic marketplace.

Thus, when customers attempt to sell an item back to an electronic marketplace, such customers usually must accept either a generic offered price that is based on the anticipated condition of an average item of the same age as the item to be returned by the customer, and not on the specific condition of the customer's item. Moreover, even where the customer and the electronic marketplace agree on terms to repurchase the item, the customer must transport the item to a post office or other delivery facility, or otherwise cause the item to be individually delivered to a return center for the electronic marketplace. Alternatively, in order for an electronic marketplace to conduct an actual evaluation of the item, the customer must ship the item to the return center for the electronic marketplace. If the electronic marketplace deems the item worthy of a repurchase offer, and the customer chooses to accept the offer, then the marketplace may retain the item in one or more facilities and update its inventory levels accordingly, and the customer may receive a check or other credit from the marketplace. If the customer declines the offer, or if the electronic marketplace declines to extend an offer to the customer, however, the item must be returned to the customer without a transaction being made.

The costs of the uncertainty, the delays and the friction in the market that are encountered by customers who wish to return their items for purchase by the electronic marketplace, or by an electronic marketplace that wishes to purchase such items from customers, frequently result in a lower repurchase price paid to the customer.

### BRIEF DESCRIPTION OF THE DRAWINGS

FIG. 1 is a block diagram of an illustrative system for automatically receiving returned items, in accordance with embodiments of the present disclosure.

FIG. 2 is a front perspective view of an illustrative automated item return machine, in accordance with embodiments of the present disclosure.

FIGS. 3A and 3B are front views of a portion of the automated item return machine shown in FIG. 2, in accordance with embodiments of the present disclosure.

FIG. 4 is a rear perspective view of the automated item return machine shown in FIG. 2, in accordance with embodiments of the present disclosure.

FIG. 5 is a rear perspective view of the automated item return machine shown in FIG. 2, in accordance with embodiments of the present disclosure.

FIG. 6 is a block diagram of an illustrative system for automatically receiving returned items, in accordance with other embodiments of the present disclosure.

FIG. 7 is a flow chart of an illustrative process for automatically receiving returned items, in accordance with embodiments of the present disclosure.

FIG. 8 is a flow chart of an illustrative process for automatically receiving returned items, in accordance with other embodiments of the present disclosure.

### DETAILED DESCRIPTION

As is set forth in greater detail below, the present disclosure is directed to systems and methods for automatically receiving returned items from customers, such as books. Specifically, the systems and methods for automatically receiving returned items are directed to providing one or more dedicated machines or facilities for receiving a returned item from a customer, determining the condition of the returned item, determining appropriate terms of a purchase of the returned item, generating an offer to purchase the item from the customer according to the terms, remitting a credit to the customer for the item, and returning the item to inventory. The systems and methods described herein may further prepare returned items for storage within the machine or at a designated location, and/or for delivery to a return center or other facility associated with an electronic marketplace or to another customer.

Presently, when a customer purchases and receives an item from an electronic marketplace, and either chooses to return the item, or attempts to offer the item for sale back to the marketplace, the customer must usually do so in accordance with an established return policy, or offer the item back to the electronic marketplace at an established resale rate or price. Each individual customer who wishes to return or sell an item to a marketplace must also cause the item to be delivered to a return center or other facility associated with the electronic marketplace, such as by bringing the item to a post office or other courier. Any delays associated with transporting the item to the electronic marketplace (e.g., evaluating the condition of the item, determining acceptable terms for the repurchase of the item, or establishing that the terms have been accepted) may have an adverse effect on the purchase price paid to the customer for the item, or on the ability of an electronic marketplace to restore the item to inventory and promptly make the item available for resale to other customers.

The systems and methods of the present disclosure provide one or more advantages over the prior art in this regard. According to one embodiment of the present disclosure, an automated return machine or facility may receive a returnable item, such as a book, within a chamber, a cavity or other designated station of the machine. Once a returnable item has been received therein, the automated return machine or facility may determine one or more attributes of the item, including a mass or weight of the item; a dimension of the item (e.g., a length, a height or a width of the item); a condition of the item (which may be expressed in qualitative or quantitative terms); or a label or identifier for the item, such as a cover or optically readable marking on, or affixed to, the item, including a book cover or binding, or the digits of an International Standard Book Number (ISBN), a Universal Product Code (UPC), a stock keeping unit (SKU) identifier, a model number, or a bar code indicative of such a number. The attributes may be determined using one or more devices that may be provided within, attached to or otherwise affiliated with the automated return machine, such as a camera, an optical reading device, a scale or any other relevant apparatus.

According to yet another embodiment of the present disclosure, such attributes may be utilized to determine an identity of the item, or to assess a condition of the item, and the identity and/or condition may be utilized to generate an offer for the repurchase of the item from the customer. For example, where one or more photographs of surfaces of a book that has been inserted into an automated return machine are captured (e.g., a photograph of an external surface, such as a cover, spine or edge, or an internal surface, such as one or more pages), the photographs may be optically scanned or evaluated (e.g., using optical character recognition, or “OCR”) in order to determine whether any characters (e.g., letters or numbers) or readable symbols (e.g., bar codes) are expressed therein. Any characters that may be identified within the photographs may be compared to a list or other registry of authors, titles, publication dates, editions, versions, ISBNs or any other identifying information in order to determine or confirm the identity of the book. Moreover, an identity and/or a condition of an item may be confirmed based on multiple attributes. For example, where the word “civil” is recognized from a cover of a book, and a mass of the book is determined to be approximately 320 grams, the book may be confirmed to be a paperback copy of A Civil Action (1995), by Jonathan Haar, which has a consistent mass, and not either a hardcover version of The Civil War: A Narrative (1986), by Shelby Foote, which has a mass of approximately 1.14 kilograms, or a softbound copy of Federal Rules of Civil Procedure (2012), which has a mass of approximately 400 grams, which share the word “civil” in their respective titles, but have substantially different masses.

Additionally, photographs or other images captured of an item in its present condition may be compared to one or more baseline or reference photographs of the item in an original, pristine or new condition, in order to identify any differences in colors, shapes or other features expressed in each of the photographs (e.g., faded colors, broken or dented surfaces). For example, one or more photographs of a book's cover, hinge or joint (e.g., an indented line along the cover of a book which bends as the cover is opened and closed), spine (e.g., an outer portion of the book that shows when the book is placed on a bookshelf), endleaf (e.g., a sheet affixed to the inside cover and forming the first and last pages of the book), fore-edge (e.g., unbound edges of the book's pages, opposite the spine), head and headcap (e.g., a top edge of the boards, spine and text block of a book when the book rests upright on a shelf), tail and tailcap (e.g., a bottom edge of the boards, spine and text block of a book when the book rests upright on a shelf), book jacket or dust jacket (e.g., a separate wrapper that shrouds a cover of a book) or one or more pages may be compared to reference photographs of the book, and a vector or other metric indicative of the coherence and/or differences between the photographs may be derived. A purchase price for the item may be determined based on a depreciation of a baseline price of the item in its pristine condition, based on the coherence and/or any differences. Additionally, the photographs may be valuated at the return machine, or transmitted to an external location or service for analysis.

According to another embodiment of the present disclosure, an automated return machine may include a networked computer infrastructure having one or more computer processors. The infrastructure may provide networked connections to an electronic marketplace to other electronic commerce systems, as well as to one or more data stores that may contain information for correlating attributes with the identities of items (e.g., book masses, dimensions, colors, or photographs or images of items in “new,” pristine or unsold conditions). For example, the networked computer infrastructure may include one or more accessories or peripherals for displaying, entering or receiving information, such as computer screens or displays, as well as keyboards, printers, scanners or other like devices.

According to another embodiment of the present disclosure, the automated return machine may be placed in a central, easily accessible location, preferably in a densely populated setting such as an urban area or a college campus. When the automated return machine or facility is installed in such an area, customers (who may now be referred to as “sellers” in this context) may visit the machine or facility to obtain an offer for the purchase of an item, and may decide whether to accept or decline the offer. If the customer declines the offer, the item may be returned to the customer immediately. If the customer accepts the offer, the item may be retained within the machine or facility as the terms of the purchase agreement are confirmed and payment is remitted to the customer. For example, the machine may be adapted to disburse cash and/or coins to a customer, or to print a check or other form of voucher for the customer. Additionally, the machine may be further adapted to credit an account (e.g., a credit card account or other banking account, or a user account maintained at the electronic marketplace) on the customer's behalf. The items may then be gathered from the machine or facility individually or in bulk, and delivered to a return center for the electronic marketplace or other destination. Alternatively, the items may be held on site, and distributed to other customers in the vicinity of the machine (e.g., those who may be interested in purchasing or borrowing the item) upon request.

The automated return machine may include or be associated with one or more additional facilities for storing the item, or for preparing the item for storage or delivery. For example, the automated return machine may include a bin or other receptacle into which repurchased items may be deposited, and the bin may be retrieved and emptied on behalf of the electronic marketplace when the bin is full, or on a predetermined schedule. Additionally, the automated return machine may include one or more two-dimensional or three-dimensional individualized storage regions (e.g., cubbies, receptacles, bins, shelves or lockers) where an item may be stored and retrieved as necessary (e.g., when the item is to be returned to an electronic marketplace, or where a new buyer for the item has been located).

According to another embodiment of the present disclosure, a distribution strategy for returned items may be determined, and a returned item purchased in accordance with the present disclosure may be designated for storage, for delivery to a central return center or warehouse, or for delivery to a customer who purchased the item in resale. As is discussed above, items that have been inserted into the automated return machine by customers and repurchased by an electronic marketplace may remain within the automated return machine until they are retrieved individually or in bulk, or prepared for delivery to a return center for an electronic marketplace or another intended destination.

Moreover, a single automated return machine may be provided to accept returned items on behalf of more than one electronic marketplace. For example, an automated return machine may be adapted to purchase a returned item from a customer, and subsequently offer the returned item for sale to any of a number of electronic marketplaces, e.g., at the highest or best purchase price. Furthermore, an automated return machine may also be adapted to receive a variety of different types of items (e.g., books, compact discs or “CDs,” or digital versatile discs or “DVDs”), and subsequently distribute each of the different types of items to different respective marketplaces (e.g., a book may be distributed to an electronic marketplace specializing in the sale of books, while a CD and a DVD may be distributed to electronic marketplaces specializing in the sale of music or movies, respectively).

According to another embodiment of the present disclosure, an offered price for a repurchased item may be determined as a function of a condition of the item, an anticipated demand for the item and/or a distribution strategy. For example, the offered price may take into account any anticipated or projected demand for the item, where a peak demand for the item may be located, the costs of maintaining the item in its current location, and/or the costs of delivering the item to one or more appropriate destinations.

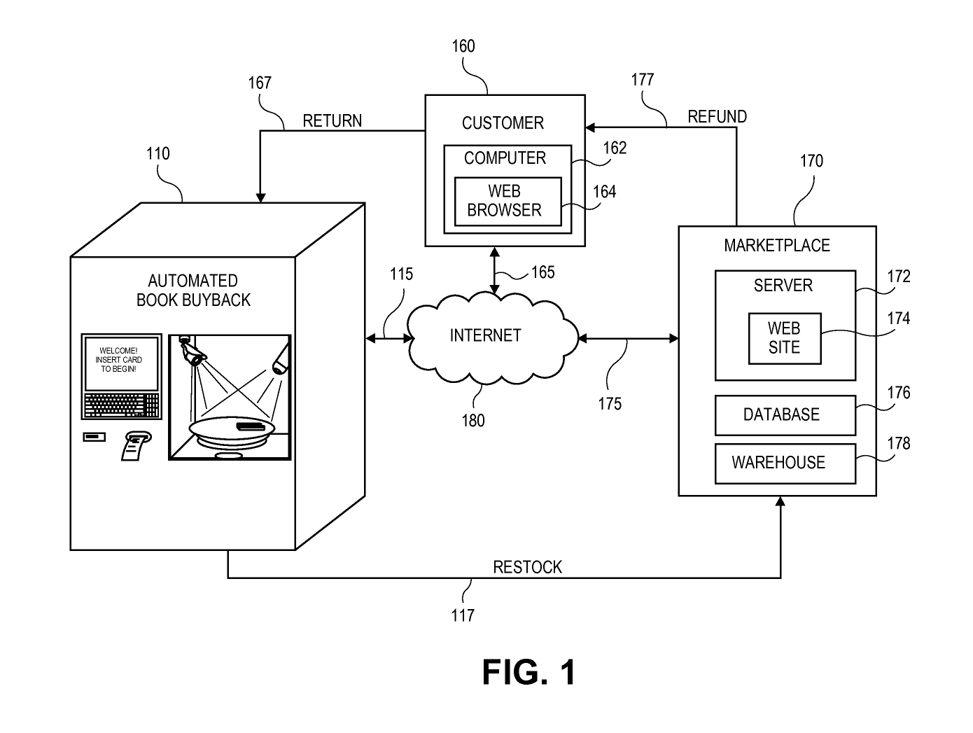

Referring to FIG. 1, a block diagram of an illustrative system 100 for automatically receiving returned items is shown. As is shown in FIG. 1, the system 100 may include an automated return machine 110 utilized by a customer 160, and a marketplace 170 that are connected to one another via a network 180, such as the Internet. The automated return machine 110 may be located at any facility that is adapted to receive returned items from customers, such as the customer 160, as is indicated by line 167, and may be used to determine the condition of the returned item, determine appropriate terms of a purchase of the returned item, generate an offer to purchase the item from the customer according to the terms, remit a credit to the customer for the item, return the item to inventory and/or designate the item for storage.

The automated return machine 110 may transmit or receive via the network 180 information in the form of digital or analog data regarding any items that have been received from customers, such as the customer 160, or regarding one or more items to be made available at the marketplace 170, or for any other purpose. For example, the automated return machine 110 may communicate with the customer 160 or the marketplace 170 in digital or analog form through one or more interfaces and may be connected to the network 180, as is indicated by line 115. Moreover, when an item has been received from a customer, such as the customer 160, the item may be returned to inventory at one or more designated storage facilities associated with the marketplace 170, such as a warehouse 178, as is indicated by line 117. Additionally, the automated return machine 110 may take any size, shape or form.

The customer 160 may be any entity or individual that wishes to download, purchase, rent, lease, borrow or otherwise obtain items (which may include goods, products, services or information of any type or form) from the marketplace 170. The customer 160 may utilize one or more computing devices, such as a computer 162, or any other like machine that may operate or access one or more software applications, such as a browser 164. For example, the computer 162 may be any computing device, such as a personal computer (PC), a kiosk, a thin client, a home computer, or a dedicated or embedded machine. Further examples of such computing devices may include laptop or tablet computers, servers, personal digital assistants (PDA), hybrid PDA/mobile phones, mobile phones, electronic book readers, set-top boxes, cameras, digital media players, and the like. The computer 162 may be connected to or otherwise communicate with the automated return machine 110 or the marketplace 170 through the network 180, as indicated by 165. Moreover, the customer 160 may furnish an item to the automated return machine 110, as indicated by line 167, and may also receive refunds for the return of items from the marketplace 170, as indicated by line 177.

The marketplace 170 may be operated by any entity or individual that wishes to make items from a variety of sources available for download, purchase, rent, lease or borrowing by customers through the use of at least one network site or page maintained using a networked computer infrastructure, such as one or more physical computer servers 172 hosting a network site 174, as well as one or more data stores 176. The marketplace 170 may also have physical or virtual access to one or more storage facilities, such as the warehouse 178. The network site 174 may be implemented using the one or more servers 172, which connect to or otherwise communicate with the one or more data stores 176, as well as the network 180, as indicated by line 175. In addition, items that are made available at the marketplace 170 or ordered therefrom by customers may be made by or obtained from one or more third party sources, such as sellers, vendors or manufacturers, or from any other source (not shown). Moreover, the marketplace 170 itself may be a seller, a vendor or a manufacturer.

Those of skill in the pertinent art will recognize that users of the automated return machine 110 or visitors to the marketplace 170, such as the customer 160, may operate a keyboard, keypad, mouse, stylus, touch screen, or other device (not shown) or method for interacting with the automated return machine 110, the computer 162, the browser 164, the marketplace 170, the server 172, the network site 174, the data store 176 and/or the warehouse 178, or to “select” an item, link, node, hub or any other aspect of the present disclosure.

The computers, servers, devices and the like described herein have the necessary electronics, software, memory, data stores, firmware, logic/state machines, microprocessors, communication links, displays or other visual or audio user interfaces, printing devices, and any other input/output interfaces to perform the functions described herein and/or achieve the results described herein. Also, those skilled in the pertinent art will recognize that users of such computers, servers, devices and the like may operate a keyboard, keypad, mouse, stylus, touch screen, or other device (not shown) or input device or technique to interact with the computers, servers, devices and the like, or to “select” an item, link, node, hub or any other aspect of the present disclosure.

Process elements described herein as being performed by or using an “automated return machine,” a “customer” or a “marketplace” may be automated and performed by their respective computer systems, or implemented within software modules (or computer programs) executed by one or more computers configured with specific computer-executable instructions. Moreover, process elements described as being performed by an “automated return machine,” a “customer” or a “marketplace” may be typically performed by a human operator via the automated return machine 110, the computer 162 and/or the server 172, but could, alternatively, be performed by an automated agent.

The automated return machine 110, the customer 160 and/or the marketplace 170 may use any network-enabled or Internet applications or features (such as an application operating on the automated return machine 110, the browser 164, the network site 174, an electronic mail (E-mail) application, or any other messaging techniques, such as short or multimedia messaging service (SMS or MMS) text messages) to connect to the network 180 or to communicate with one another. In addition, the automated return machine 110, the computer 162 and/or the server 172 may include any of a number of computing devices that are capable of communicating over the network, including but not limited to set-top boxes, personal digital assistants, mobile phones including “smartphones,” digital media players, web pads, tablet computers, laptop computers, desktop computers, electronic book readers, and the like. The protocols and components for providing communication between the automated return machine 110, the computer 162 and/or the server 172 are well known to those skilled in the art of computer communications and thus, need not be described in more detail herein.

The data and/or computer executable instructions, programs, firmware, software and the like (also referred to herein as “computer executable” components, modules or instruction sets) described herein may be stored on a non-transitory computer-readable medium that is within or accessible by the automated return machine 110, the computer 162 and/or the server 172, and may have sequences of instructions that, when executed by a processor (such as a central processing unit, or CPU), cause the processor to perform all or a portion of the functions and/or methods described herein. Such computer executable instructions, programs, software and the like may be loaded into the memory of the automated return machine 110, the computer 162 and/or the server 172 using a drive mechanism associated with the computer-readable medium, such as a floppy drive, CD-ROM drive, DVD-ROM drive, network interface, or the like, or via external connections.

Some embodiments of the systems and methods of the present disclosure may also be provided as a computer executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), erasable programmable read-only memories (EPROMs), electrically erasable programmable read-only memories (EEPROMs), flash memory, magnetic or optical cards, solid-state memory devices, or other types of media/machine-readable medium that may be suitable for storing electronic instructions.

For the purposes of illustration, some of the systems and methods disclosed herein may be referenced primarily in the context of systems for receiving items (e.g., books, apparel, jewelry, electronics, appliances, etc.) from customers. Such a system may include a free-standing return machine, such as the automated return machine 110, and may determine one or more terms of an agreement for the repurchase of the items that is to be executed between such a customer 160 and an electronic marketplace 170, as shown in FIG. 1. As will be recognized by those skilled in the art, however, the systems and methods disclosed herein may also be used in many other situations, and their utility is not limited to any of the embodiments described herein.

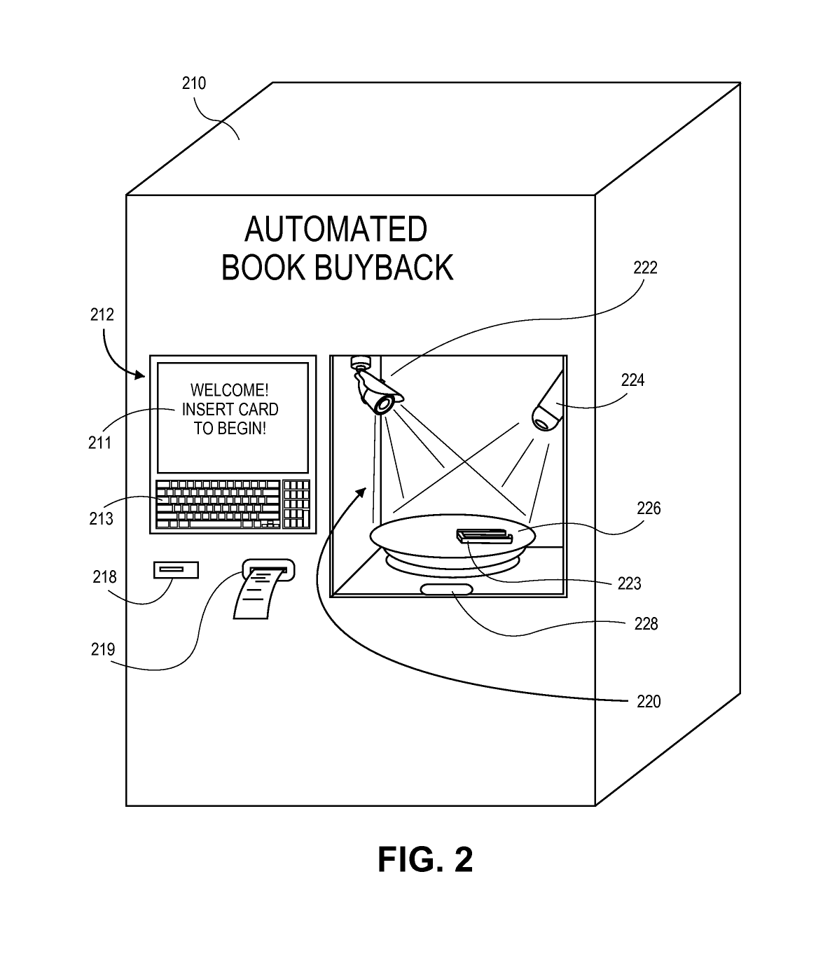

Referring to FIG. 2, one embodiment of an automated return machine 210 according to the present disclosure is shown. The automated return machine 210 may include a computer 212 and a chamber 220 for receiving items, such as books, electronics, jewelry, etc. The computer 212 may include a screen 211 and a keyboard 213, a card reader 218 and a printer 219. The screen 211 is intended to display information to a customer who attempts to return an item to a marketplace 170 via the machine 210. The keyboard 213 is intended to receive information from a customer who attempts to return an item to a marketplace via the machine 210. Alternatively, the screen 211 may be adapted to receive inputs directly from a customer, e.g., the screen 211 may be a “touch screen” that functions as both a visual display and the keyboard 213.

The card reader 218 may be adapted to receive authenticating or purchasing information in physical form, such as in the form of one or more physical payment instruments (e.g., credit cards or debit cards), which may be preprogrammed with one or more numbers, codes or other information that may identify a customer and/or an account affiliated with the customer. Additionally, those skilled in the art will recognize that one or more other devices may be used to receive such information from customers, including radio frequency identification (or “RFID”) components, infrared or other optical scanners or readers, or any like devices. The printer 219 may be a peripheral attached to or otherwise installed within the machine 210 and may generate output in the form of one or more hard copies of paper or other printed materials. The chamber 220 may be a portion or subset of the machine 210 having one or more cavities or regions for receiving items that are to be inserted therein by customers and offered for resale. The chamber 220 may include a camera 222, an easel 223, an optical reader 224, a scale 226 and an access door 228.

The camera 222 may be adapted to capture one or more photographs of internal or external surfaces of an item within the chamber 220. The easel 223 may provide support for an item in a particular orientation for an item within the chamber 220. For example, the easel 223 may be adapted to position an item such that one or more faces thereof is placed within a field of view of the camera 222 or the optical reader 224. Additionally, the easel 223 may be adapted with manual or automated features for exposing one or more internal surfaces of an item (e.g., for opening a book to a particular page therein) for evaluation, such as by the camera 222 or the optical reader 224. For example, the easel 223 may clip or grip a portion of a cover and/or one or more pages of a book, and open or expose the book to a random or predetermined page for evaluation.

The optical reader 224 may read, scan or otherwise evaluate any optically readable representations of data that may be included within, attached to or otherwise affixed on an item. Such representations may include a standard bar code, a “quick response” (or “QR”) code, or any written or printed letters, numbers or other characters that may be located on one or more internal or external surfaces of the item. Although the chamber 220 of FIG. 2 is depicted as including one camera 222 and one optical reader 224, automated return machines according to the present disclosure may include any number and/or combination of cameras, readers and/or scanners for evaluating multiple surfaces of an item inserted therein. For examples, sufficient cameras, readers and/or scanners may be provided to evaluate each of the six external surfaces of a cube-shaped or rectangular solid-shaped item.

The scale 226 may include one or more measuring instruments such as balances, spring scales, digital scales or any other components that are adapted to determine or estimate a mass of an item. The access door 228 may open or close to enable or secure, respectively, access to the chamber 220.

As discussed above, embodiments of an automated return machine of the present disclosure, such as the automated return machine 210 shown in FIG. 2, may include the computer 212, the screen 211 and/or the keyboard 213. A customer may utilize the computer 212 in order to identify him or herself using one or more applications operating thereon (e.g., by entering a user identifier such as an E-mail address and/or a password via the screen 211 or the keyboard 213). The customer may the place an item within the chamber 220 of the automated return machine 210 and the machine may determine one or more attributes of the item. For example, the automated return machine 210 may photograph one or more internal or external surfaces of the item using the camera 222, and may scan or read any internal or external markings thereon using the optical reader 224. Additionally, the automated return machine 210 may determine a mass or weight of the item using the scale 226.

Any information, data or attributes that may be identified regarding the item may then be reviewed and analyzed to determine an identity of the item or to assess a condition of the item. Once the item has been identified and a condition of the item has been determined, one or more terms of an offer to purchase the item may be presented to the customer, such as on the screen 211. The customer may review the terms and either accept or decline the offer, using the keyboard 213 or any other peripheral or interface of the automated return machine 210 or the computer 212. If the offer is declined, the customer may recover the item from the chamber 220. If the offer is accepted, the automated return machine 210 may secure the item therein, process a transaction in accordance with the agreed upon terms, remit any applicable sums to the customer, and report to the electronic marketplace 170 that the item is within its control. The electronic marketplace 170 may then update its inventory levels and make the item available for resale to customers.

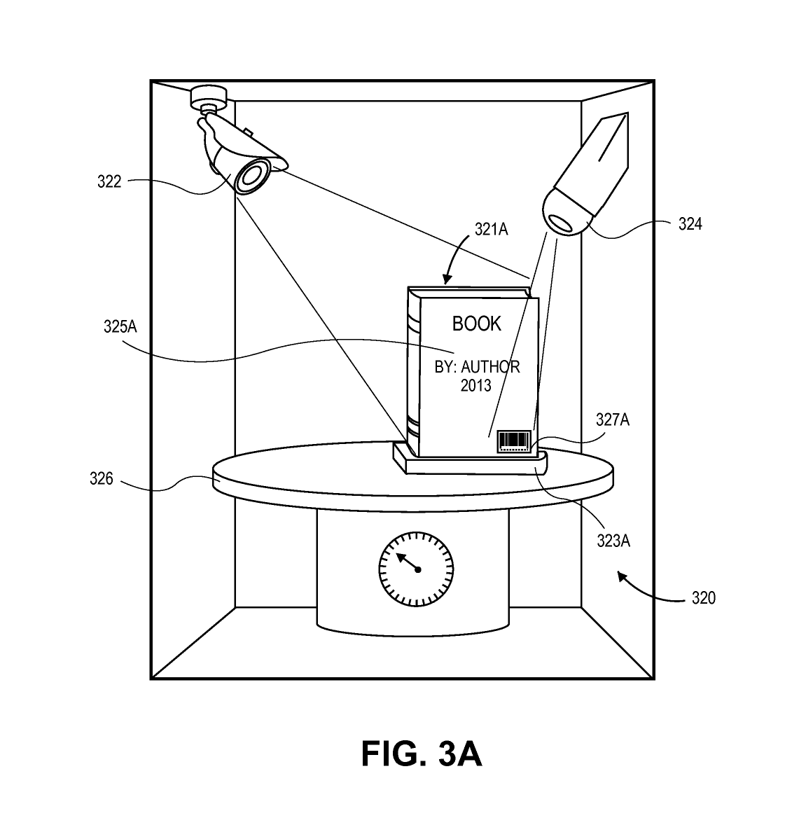

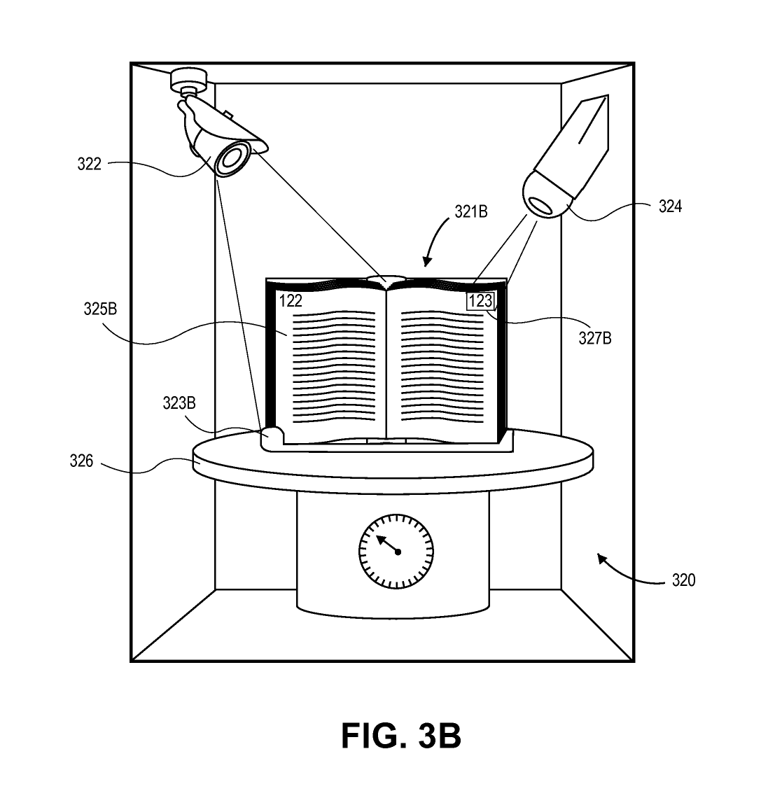

Referring to FIGS. 3A and 3B, a front view of a portion of an automated item return machine (viz., a chamber for receiving items) in accordance with embodiments of the present disclosure is shown. Except where otherwise noted, reference numerals preceded by the number “3” in FIG. 3A or 3B indicate components or features that are similar to components or features having reference numerals preceded by the number “2” shown in FIG. 2.

As is shown in FIG. 3A, a chamber 320 of an automated return machine having an item (viz., a book 321A) therein is shown. The chamber 320 may include a camera 322, which is shown as capturing an image of one or more external surfaces of the book 321A (e.g., a cover 325A of the book 321A). The chamber 320 may also include an optical reader 324, which is shown as scanning or reading a bar code 327A on an external surface of the book 321A. Additionally, the book 321A is also shown as positioned by an easel 323A and placed on a scale 326 for determining a mass thereof.

As is also discussed above, the systems and methods of the present disclosure may provide for the evaluation of one or more internal surfaces of an item. Referring to FIG. 3B, a chamber 320 of an automated return machine 300 having an item (viz., the book 321B) therein is shown. The chamber 320 may include a camera 322 and an optical reader 324. The book 321B is shown as positioned by the easel 323B, which has opened the book to expose a predetermined portion thereof. The camera 322 is shown as capturing an image of one or more internal surfaces of the book 321B (e.g., a page 325B within the book 321B) and the optical reader 324 is shown as reading a page number 327B of the book 321B.

As is discussed above, one or more systems and methods of the present disclosure may be utilized to obtain one or more attributes of an item, and such attributes may be used to determine or confirm an identity of the item, as well as to assess a condition of the item. For example, a photograph of the cover 325A of the book 321A of FIG. 3A may be scanned or analyzed to identify any letters, numbers or other characters thereon, which may be indexed or searched against a table or set of titles in order to determine or confirm an identity of the book. Likewise, a photograph of the page 325B of FIG. 3B may be scanned or analyzed to identify any letters, numbers or other characters thereon, which may also be indexed or searched against the contents of a plurality of books that may be stored or described in one or more data stores, in order to determine or confirm an identity of the book. Additionally, the bar code 327A of FIG. 3A may be scanned to identify a number (e.g., an ISBN) associated with the book 321A, which may also be indexed or searched against a table of titles or other unique identifiers associated with books, in order to determine an identity of the book 321A. Similarly, the page number 327B of FIG. 3B may be scanned to identify the page to which the book 321B is opened.

Analyses of the various attributes of items that may be obtained within an automated return machine may be performed locally, such as by the computer 212 of the automated return machine 210 of FIG. 2, remotely at a marketplace, such as the server 172 of the marketplace 170 of FIG. 1, or by some combination thereof. Alternatively, such attributes may be transmitted to a pool of human workers for analysis, such as to identify the item, or to determine a condition thereof based on one or more of such attributes. For example, the pool of workers may be an external organization that employs or contracts with an electronic marketplace, and may be associated with a crowdsourcing Internet site or organization, wherein each of the workers in the pool may be trained to analyze the express or implicit attributes of the items obtained within one or more automated return machines.

Once an identity of an item such as a book 321A or 321B has been determined, a photograph of an external surface of the book 321A, 321B (such as the cover 325A or any edge of the book 321A of FIG. 3A), an internal surface of the book 321B (such as the page 325B) or any other internal portion of the book 321B, may be analyzed and compared to a baseline photograph of the corresponding surfaces of the book 321A, 321B, and any differences between the book 321A, 321B at the time of its presentment and the book 321A, 321B in its original condition may be identified, such as by deriving a vector or other metric indicative of the coherence and/or differences between the photographs. For example, a photograph of the book 321A, 321B may reveal faded colors or other forms of discoloration, or one or more missing, malfunctioning or defective elements of the book (e.g., a cracked spine, torn pages, stains) as compared to the baseline photograph, and such a vector or other metric may be used to derive a purchase price for the item. Moreover, a mass of the book 321A, 321B may be determined by the scale 326, which may also be used to confirm an identity of an item or whether the item is missing any particular elements (e.g., whether the book 321A, 321B is missing any pages or chapters). Any and all attributes that may have been identified regarding a particular item may be utilized to determine or confirm an identity of the item, or to assess a condition of the item, and the identity and condition of the item may further be utilized to generate one or more terms of an offer for the purchase of the item.

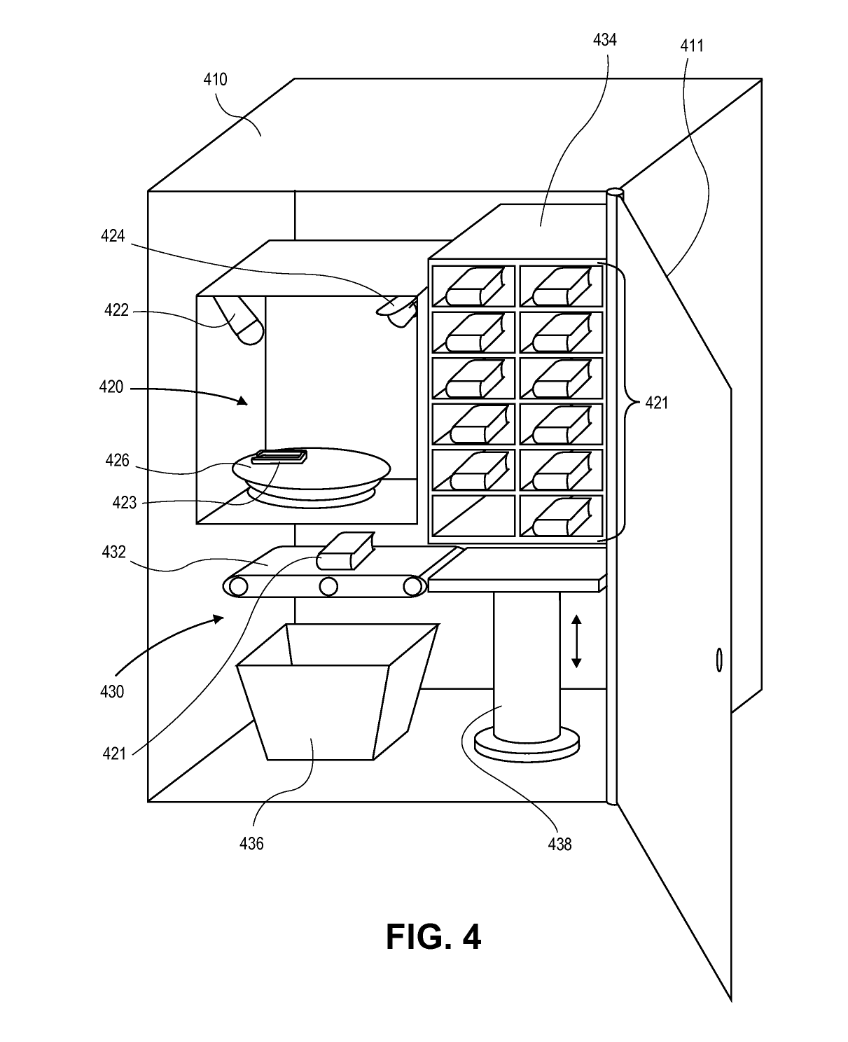

As is discussed above, an automated return machine may include one or more features for receiving and storing an item therein. When a customer agrees to sell an item at an automated return machine, the item may be retained within the automated return machine and prepared for storage or delivery, such as by being placed within one or more specific storage locations within the machine. Referring to FIG. 4, a rear view of a portion of an automated item return machine in accordance with embodiments of the present disclosure is shown. Except where otherwise noted, reference numerals preceded by the number “4” in FIG. 4 indicate components or features that are similar to components or features having reference numerals preceded by the number “3” shown in FIGS. 3A and 3B, or the number “2” shown in FIG. 2.

As is shown in FIG. 4, the automated return machine 410 may include a chamber 420 and a storage facility 430 within a rear door 411 of the automated return machine 410. The chamber 420 may include a camera 422 for photographing one or more external surfaces of an item and an optical reader 424 for interpreting any external markings thereon (e.g., text, numbers or bar codes), as well as a scale 426 for determining a mass of the item. The storage facility 430 may include a conveyor 432 for transferring an item (e.g., a book 421) from the chamber 420 to an elevator 438, where the item may be lowered into a receptacle 436 for unloading, or raised and deposited within one or more individualized storage regions 434 (e.g., cubbies, bins, shelves or lockers) for permanent or semi-permanent storage. For example, where the automated return machine 410 is regularly serviced or emptied according to a schedule, the item may be lowered into the receptacle 436 using the elevator 438. Where an item is intended to remain within the automated return machine 410 for an extended period of time, or where additional security may be required for an item, the item may be raised into one or more of the regions 434 using the elevator 438 and stored there until the item is manually or automatically removed.

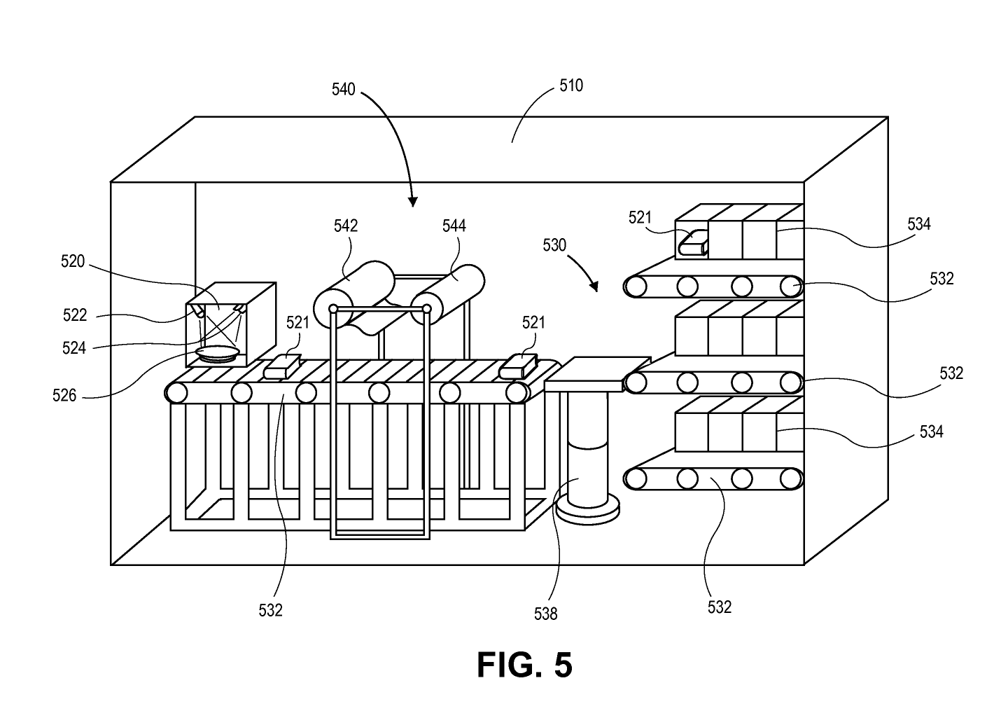

As is also discussed above, an automated return machine may include one or more features for preparing an item for storage or delivery, such as by wrapping, boxing, bagging, sealing or readying the item to be placed in storage (e.g., shrouding an item in air-pocketed cellular packaging, or “bubble wrap”). Referring to FIG. 5, a rear view of a portion of an automated item return machine in accordance with embodiments of the present disclosure is shown. Except where otherwise noted, reference numerals preceded by the number “5” in FIG. 5 indicate components or features that are similar to components or features having reference numerals preceded by the number “4” shown in FIG. 4, the number “3” shown in FIGS. 3A and 3B, or the number “2” shown in FIG. 2.

As is shown in FIG. 5, the automated return machine 510 may include a chamber 520, a storage facility 530 and a packaging facility 540. The chamber 520 may include a camera 522 for photographing one or more external surfaces of an item, an optical reader 524 for interpreting any external markings thereon and a scale 526 for determining a mass of the item. The storage facility 530 may include a conveyor 532 for transferring an item (e.g., a book 521) from the chamber 520 to an elevator 538, where the item may be raised or lowered onto one or more other conveyors 532 and deposited within one or more individualized storage regions 534 (e.g., cubbies, bins, shelves or lockers) for permanent or semi-permanent storage. The packaging facility 540 may include a plastic wrapping station 542 for wrapping an item in film, and a paper wrapping station 544 for wrapping the item in parcel paper, as the item traverses on the conveyor 532. Other facilities for preparing or packaging and item for storage or delivery may be utilized in accordance with the present disclosure, including automated boxing or bagging machines, or stations for applying tape, adhesives, shipping labels or any other covering or tag to an item. Alternatively, where the external surfaces of an item are sufficiently durable, the item need not require any such preparation at all.

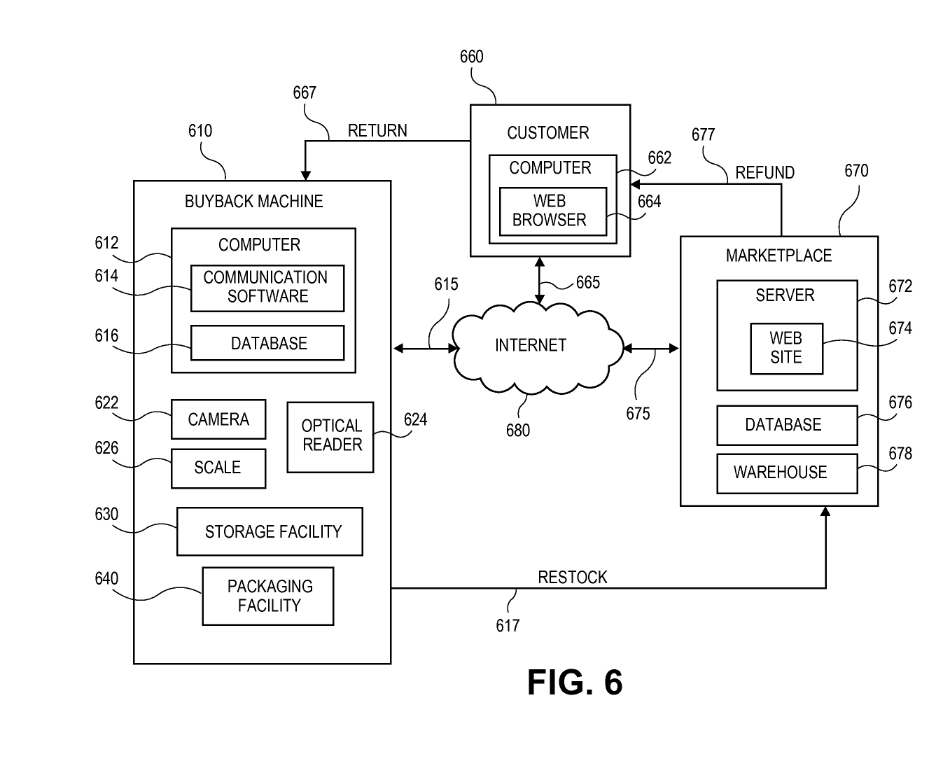

As is discussed above, some embodiments of an automated return machine according to the present disclosure may include various interrelated computer components, peripherals and/or accessories. Such components enable the machine to communicate with customers, electronic marketplaces and/or any other external entities; to determine one or more attributes of an item to be returned; to execute any transactions for the repurchase of items; or to designate and prepare items for storage or delivery. Referring to FIG. 6, a block diagram of another embodiment of an illustrative system 600 for automatically receiving returned items is shown. Except where otherwise noted, reference numerals preceded by the number “6” in FIG. 6 indicate components or features that are similar to components or features having reference numerals preceded by the number “1” shown in FIG. 1.

As is shown in FIG. 6, the system 600 may include an automated return machine 610 utilized by a customer 660, and a marketplace 670. The automated return machine 610 and marketplace 670 may be connected to one another via a network 680. The automated return machine 610 may include a computer 612 having a set of communication software 614 operating thereon, and a data store 616. The computer 612 may include one or more components commonly found in computing devices that are capable of communicating over a network, including but not limited to set-top boxes, personal digital assistants, mobile phones including “smartphones,” digital media players, web pads, tablet computers, laptop computers, desktop computers, electronic book readers, and the like. Additionally, the communication software 614 may comprise one or more applications for receiving interactions from customers, such as the customer 610, and communicating with the marketplace 670, including one or more browsers or Internet-accessible applications providing any of a number of interactive features. Additionally, those of ordinary skill in the art would recognize that customers may use a keyboard, keypad, mouse, stylus, touch screen, or other device (not shown) or technique for interacting with the automated return machine 610 and/or the computer 612.

The data store 616 may comprise one or more data stores for storing information or data regarding customers 660, delivery schedules, transportation options, storage locations, items (e.g., purchase prices and resale histories), available inventory levels at the marketplace 670 and/or any other pertinent information. For example, the data store 616 may include information regarding a plurality of items, such as attributes, photographs or details of items that may be compared to or contrasted with attributes, photographs or other details regarding an item that a customer 660, intends to sell to the marketplace 670.

The automated return machine 610 may include one or more facilities for receiving items from customers 660, as is indicated by line 667. For example, the automated return machine 610 may include a chamber, such as one or more of the chambers 220, 320, 420, 520 of FIGS. 2, 3A, 3B, 4 and 5, into which one or more items may be inserted by a customer and evaluated. The automated return machine 610 may also include one or more internal or external devices that may receive information regarding a customer or an item, including, but not limited to, a keyboard, keypad, touch screen, card reader (such as the card reader 218 of FIG. 2), RFID reader or any other device for interactively receiving information from customers.

The automated return machine 610 may further include one or more internal or external devices that may be controlled by the computer 612, and used to determine one or more attributes of an item. As is shown in FIG. 6, the automated return machine 610 may include one or more cameras 622 and/or optical readers 624, which may be used to detect information regarding an item from one or more external surfaces thereof, as is described above. For example, one or more photographs of an item's external surfaces may be captured and analyzed to identify the item and also to assess a condition of the item. In addition, any external markings thereon (e.g., text, numbers, characters or codes) may be further analyzed to identify the item. The automated return machine 610 may further include one or more scales 626 for determining a mass or weight of an item. Once such information, data and/or attributes is gathered for an item utilizing the cameras 622, optical readers 624 or scales 626 shown in FIG. 6, the information, data and/or attributes may be internally analyzed by the computer 612 or transmitted to one or more external locations, such as the marketplace 670, for analysis.

As is shown in FIG. 6, the automated return machine 610 may further include a storage facility 630 and/or a packaging facility 640 for preparing the item for storage within the automated return machine 610 or for delivery to one or more external locations, such as the warehouse 678 associated with the marketplace 670, as is indicated by line 617. For example, an automated return machine 610 may include one or more of the components of the storage facilities 430, 530 of FIGS. 4 and 5, or the packaging facility 540 of FIG. 5, including conveyors and/or elevators for positioning the items within the machine 610 or one or more receptacles and/or individualized storage regions for retaining the items within the machine 610. Any of the components of the storage facility 630 and/or the packaging facility 640 may be individually or collectively controlled based on instructions provided by the computer 612 or another computing device that may be located external to the computer 612, such as the server 672 of the marketplace 670. Moreover, the automated return machine 610 may include one or more facilities for enabling the transfer of items stored or maintained therein to an external location, including ramps, docks or other like features.

Accordingly, the automated return machines of the present disclosure, such as the automated return machines 210, 410, 510, 610 of FIGS. 2 and 4-6, may receive an item from a customer who is interested in selling the item to an external entity, such as an electronic marketplace, and automatically identify the item and determine a condition thereof. Once the item has been identified, and a condition of the item has been determined, terms of an agreement for the repurchase of the item may be determined, and an offer to repurchase the item according to the agreement may be presented to the customer. Should the customer accept the offer, the item may be retained within the machine, and an appropriate credit or amount of funds may be transferred to the customer in accordance with the terms. Should the customer decline the offer, the item may be placed in the inventory of the marketplace and offered for resale to other customers.

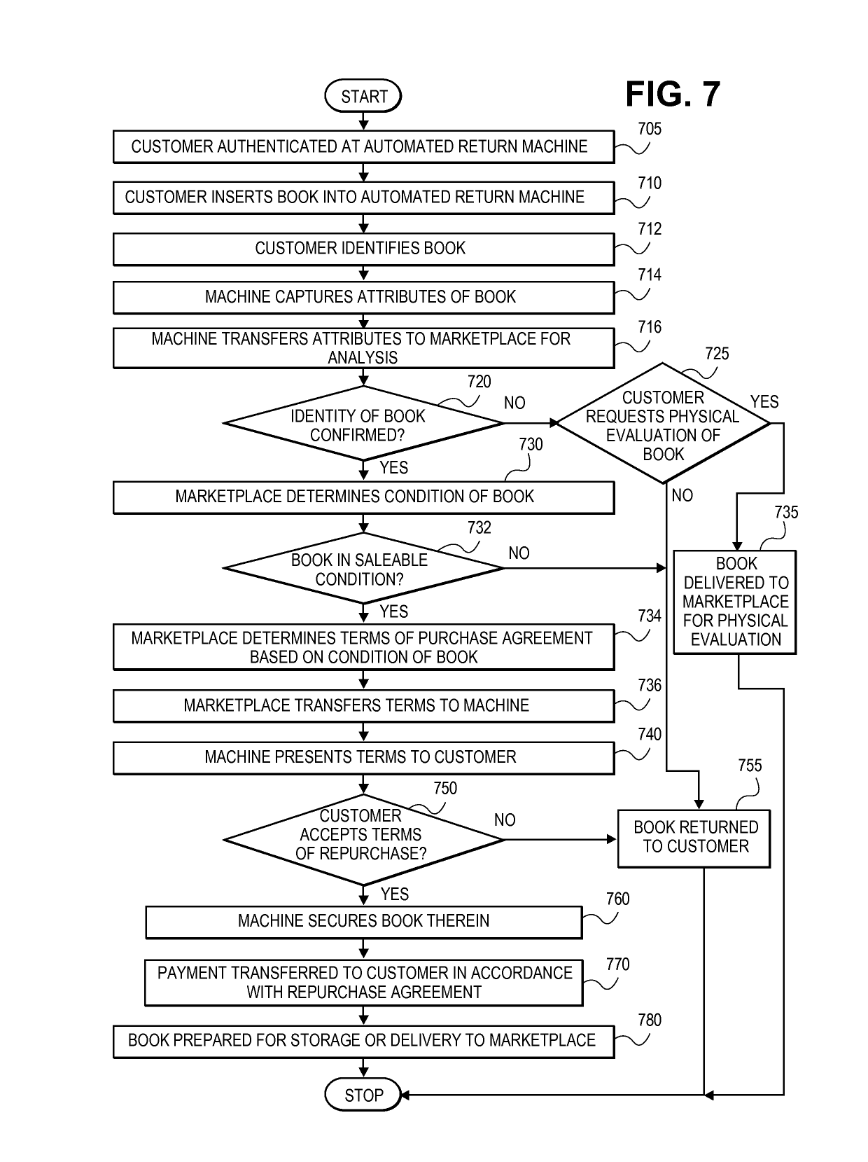

Referring to FIG. 7, a flow chart 700 of an illustrative process for automatically receiving returned items (viz., a book) on behalf of an electronic marketplace in accordance with embodiments of the present disclosure is shown. At block 705, a customer is authenticated at an automated return machine. For example, a customer may identify himself or herself by providing one or more inputs via one or more input devices, such as a touch screen 211 or keyboard 213 shown in FIG. 2, or by entering a card including one or more authenticating characteristics (e.g., a credit card or debit card associated with the customer) into a card reader 218 shown in FIG. 2.

After the customer has been authenticated at block 705, an item, such as a book, to be returned may be identified, and a condition of the book may be assessed. More specifically, at block 710, the customer may insert the book into the automated return machine, and at block 712, the customer may provide identifying information regarding the book (e.g., a title of the book, an author of the book and/or one or more editions or special features of the particular book). At block 714, the machine may capture one or more attributes of the book, which may be expressed in a photograph of an external surface of the book (e.g., a cover, a hinge or joint, a spine, an end leaf, a head or headcap, a tail or tailcap, or a book jacket or dust jacket), or an external marking on such a surface (e.g., text, numbers, characters or bar codes), and may also include a mass of the book. At block 716, the attributes that have been captured from the book may be transferred from the machine to an electronic marketplace for analysis. The attributes may be expressed in the form of one or more electronic messages, which may be transferred to the marketplace by one or more standard techniques.

At block 720, the process determines whether the identity of the book may be confirmed. For example, one or more servers associated with the marketplace, such as physical computer servers 172, may analyze all available information, data or attributes regarding the item, including any information that may be provided by the customer at block 712, as well as any data or attributes of the item that may be determined at block 714, to confirm the title, author, version and/or edition of the book. The marketplace server(s) may also corroborate any information received from the customer at block 712 or any data or attributes obtained at block 714 against a purchase history of the customer, to determine whether the customer previously purchased a book that is consistent with the information provided by the customer or the data or attributes that were obtained. If an identity of the book cannot be determined at block 720, then the customer is prompted to determine whether he or she would like to have the book physically evaluated (e.g., by a human) at block 725. If the customer chooses to have the book physically evaluated, then the process advances to block 735, where the book is retained by the machine so that it may be delivered to the marketplace or another dedicated location for evaluation, and the process ends. If the customer declines to have the book physically evaluated, then the process advances to block 755, where the book is returned to the customer. For example, referring to the automated return machine 210 of FIG. 2, the access door 228 may open, and the item may be retrieved by the customer.

If the identity of the book is determined at block 720, then the process may advance to block 730, where the marketplace server(s) determines a condition of the book. For example, using the information, data and/or attributes that may be received from a customer, identified from a book and/or determined based on a customer's purchasing history, the marketplace server(s) may estimate the condition of the book, such as by comparing a captured photograph or a measured mass of the book to a baseline photograph or an original mass of the book. Any other techniques or methods for determining or estimating a condition of an item, such as a book, may be utilized in accordance with the systems and methods of the present disclosure.

At block 732, the process determines whether the book is in a saleable condition. A determination as to whether a condition of a book is saleable may be based on any available information, data or attributes regarding the book, and may be a function of the book itself, or a demand for the book via resale. For example, a worn and weathered copy of Harry Potter and the Sorcerer's Stone (1997) by J. K. Rowling may have a different value than a worn or weathered copy of The Casual Vacancy (2012) by the same author, which is still available on the market and has not yet reached the level of popularity of the former book. Likewise, at the conclusion of a college semester, the demand for a used textbook that is required for use by students in the following college semester may have a different value than the demand for a used textbook that is not required for use by students until the following year, even if the books are in the same condition. If the book is determined to be not in a saleable condition, then the process advances to block 755, where the item is returned to the customer.

If the book is determined to be in a saleable condition at block 732, then the process advances to block 734, where the marketplace server(s) determine the terms of a repurchase agreement based at least in part on the condition of the book. Such terms may consider any pertinent factor regarding the book, primarily a demand for such a book in its present condition, a location where the demand for the book in its present condition may be greatest, or past sales of the book, and may be obtained by resort to a lookup table or other physical or virtual resource. At block 736, the marketplace server(s) transfer the terms of the repurchase agreement to the machine, and at block 740, the machine presents the terms to the customer, e.g., on the screen 211 or on a printed hard copy received from the printer 219 of FIG. 2. At block 750, it is determined whether the customer accepts the terms of the repurchase agreement. If the customer declines to accept the terms of the repurchase agreement, then the process advances to block 755, where the item is returned to the customer.

If the customer accepts the terms of the repurchase agreement, then the process advances to block 760, where the machine secures the book therein, and to block 770, where payment is transferred to the customer in accordance with the repurchase agreement. For example, where the book has been inserted into the automated return machine 210 of FIG. 2, the access door 228 may be locked in place, and a credit or other form of funds may be transferred from the marketplace to the customer, such as is shown by line 177 of FIG. 1. The credit may take the form of cash, a check, a voucher, a credit to an account associated with the customer (e.g., an account maintained at a bank or with the marketplace), or any other known form of payment. At block 780, the book may be prepared for storage or delivery to a return center or other facility associated with marketplace, and the process ends. For example, where the book has been inserted into the automated return machine 410 of FIG. 4, the book may be placed in the receptacle 436 or within one or more of the individualized storage regions 434 for permanent or semi-permanent storage.

Accordingly, the systems and methods of the present disclosure may be utilized to receive an item, such as a book, from a customer, and may determine an identity and a condition of the item using one or more computer-related machines. Once the identity and/or the condition of the item are determined, one or more terms of an offer to repurchase the item may be derived, and the offer may be presented to the customer. Should the customer decline the offer, the customer is free to retrieve the item. If, however, the customer elects to accept the offer, the customer may be credited for the repurchase price of the item, and the item may be returned to inventory at the marketplace, or otherwise made available for resale to other customers.

An offered price for the repurchase of an item may be determined based on any number of factors, such as any intended use for the item, any anticipated or projected demand for the item, or any strategy for distributing the item for resale (e.g., storing or delivering the item), or any relevant times or dates thereof. The systems and methods disclosed herein may utilize any relevant factor regarding an item, such as a use, a demand or a distribution strategy for the item, in determining whether to offer to repurchase the item from a customer, or in determining a price at which an offer for the item may be presented to the customer.

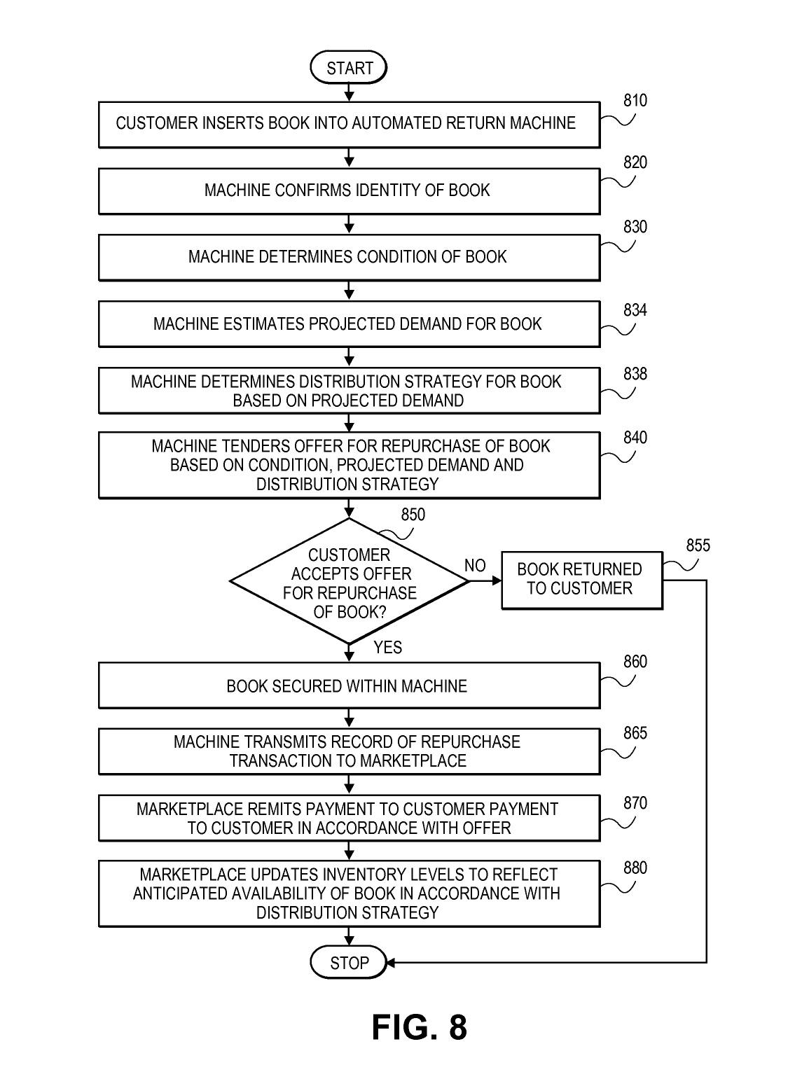

Referring to FIG. 8, a flow chart 800 of another illustrative process for automatically receiving returned items (viz., a book) on behalf of an electronic marketplace in accordance with embodiments of the present disclosure is shown. Except where otherwise noted, reference numerals preceded by the number “8” in FIG. 8 indicate blocks that are similar to components or features having reference numerals preceded by the number “7” shown in FIG. 7.

At block 810, a customer inserts a book into an automated return machine, such as the machines 210, 310, 410, 510, 610 of FIG. 2, 3A, 3B or 4-6. At block 820, the machine confirms the identity of the book, and at block 830, the machine determines a condition of the book. As is discussed above, an identity and/or a condition of the book may be determined based on any number of factors, including but not limited to information received from the customer, any data or attributes that may be obtained from the book, or any purchasing records or history of the customer. The external surfaces of the book may include a bar code, a QR code or written text or numbers that may be scanned or “read” using mounted scanners and/or cameras adapted to optically recognize text or other markings on the book.

At block 834, the machine may estimate a projected demand for the book. For example, once the book has been identified, the machine may determine whether there may be a demand for the book in the vicinity of the machine or within a close proximity thereof, and the extent of such a demand. At block 838, the machine determines a distribution strategy for the book based on the projected demand. For example, the machine may determine whether to store the book therein, or to prepare the book for delivery to a return center or other facility associated with the marketplace (e.g., a warehouse) or another location based on the projected demand.

At block 840, the machine tenders an offer for the repurchase of the book based on the condition, the projected demand and the distribution strategy, such as by displaying one or more terms of the offer, e.g., on the screen 211 or on a printed hard copy received from the printer 219 of FIG. 2. The terms of the offer (which may include but are not limited to the price of the offer) may be based on the condition of the item, as well as when and where demand for the book in that condition may be anticipated, or the extent of any available space for storing the item in situ. For example, where the automated return machine is installed in a city, and a customer presents a book for repurchase, the machine may determine the demand for the book within the city, or within the surrounding environment, based on sales and resales of the book in that region. Where the automated return machine is installed on a college campus, the demand for the book may be based on the upcoming curriculum at the campus in the coming months.

At block 850, it is determined whether the customer accepts the offer to repurchase the book. If the customer declines the offer, then the process advances to block 855, where the book is returned to the customer. If, however, the customer accepts the offer, then the book is secured within the machine at block 860, and the machine transmits a record of the repurchase transaction to the marketplace at block 865. Such a record may include a confirmation that the item has been retained within the machine and that an acceptance of the offer has been received from the customer. At block 870, the marketplace remits payment for the book to the customer in accordance with the terms of the offer, such as by providing a credit or a check to the customer, as indicated by line 177 in FIG. 1. At block 880, once the item is retained within the machine, the marketplace's inventory levels may be updated to reflect the availability of the book in the condition identified at block 830, and the item may be immediately offered to customers for resale through one or more user interfaces (e.g., product detail pages).

Although the disclosure has been described herein using exemplary techniques, components, and/or processes for implementing the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure. For example, the systems and methods disclosed herein are not limited to the repurchase of books, and may be used to repurchase any portable items having some form of resale or salvage value, including but not limited to CDs, DVDs, video games, unopened bottles of wine, mobile telephones, jewelry, apparel, etc.

Furthermore, the systems and methods disclosed herein are not limited to the repurchase of items on behalf of an electronic marketplace that were originally purchased from the electronic marketplace. For example, the automated return machines may be used to receive and evaluate items that were purchased from third party sources, and to present an offer for the repurchase of such items on behalf of an electronic marketplace once an identity and a condition of the items may be determined. Thus, the systems and methods disclosed herein are not limited to the “repurchase” of items, and may also be used for direct first-time purchases of items, as well.

Additionally, although many of the embodiments of automated return machines described herein or shown in the accompanying figures include one or more cameras, scanners or readers, any number or combination of devices may be utilized to photograph, scan or interpret or items, or any markings thereon, in accordance with the systems and methods of the present disclosure. The machines disclosed herein may also provide one or more items or features for changing a position or configuration of an item inserted therein, or for exposing one or more internal portions of the item, such as the easel 323A, 323B of FIGS. 3A and 3B, or any other manual or automatic device or apparatus for rotating, reorienting or repositioning items. Furthermore, although many of the embodiments described herein include conveyors and/or elevators that may transport items in a fixed orientation through the stations described herein, such conveyors and/or elevators may be adapted to rotate the conveyors and/or elevators or items in transit to expose multiple faces of such items to any cameras, scanners or readers within such stations, or to any other devices. In addition to devices that wrap items in paper or plastic, such as the devices of the packaging facility 640 of FIG. 6, other apparatuses or devices may be included to prepare an item for storage or delivery, such as machines that may automatically box an item, or automatically insert an item into an appropriate envelope or other container.

Moreover, the data processing disclosed herein may occur in real time or in near-real time, and may be performed by one or more computer processors or devices operating on an automated return machine, or by one or more external computer processors or devices located elsewhere, such as at an electronic marketplace. Such computer devices can include any number of computer related accessories or peripherals, including but not limited to the screen, keyboard, card reader or printer shown in FIG. 2, such as a track ball, mouse or other type of device.

It should be understood that, unless otherwise explicitly or implicitly indicated herein, any of the features, characteristics, alternatives or modifications described regarding a particular embodiment herein may also be applied, used, or incorporated with any other embodiment described herein. Moreover, with respect to the one or more methods or processes of the present disclosure described herein, including but not limited to the flow charts shown in FIG. 7 or 8, or the arrangements of components shown in FIG. 1, 2, 3A, 3B or 4-6, the order in which the blocks of the methods or processes are listed is not intended to be construed as a limitation on the claimed inventions, and any number of the method or process blocks can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey that certain embodiments could include, but do not require, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or blocks are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Although the invention has been described and illustrated with respect to exemplary embodiments thereof, the foregoing and various other additions and omissions may be made therein and thereto without departing from the spirit and scope of the present disclosure.

What is claimed is:

1. An apparatus for purchasing a book from a seller, the apparatus comprising:
a chamber configured to receive the book from the seller;
a display configured to present information regarding the book received in the chamber; and
a computer processor in communication with the display, the computer processor configured to:
determine an attribute of the book;
confirm an identity of the book based at least in part on the attribute of the book;
determine a purchase price for the book based at least in part on the attribute; and
cause presentation on the display of an offer to purchase the book from the seller at the purchase price.

2. The apparatus of claim 1, wherein the attribute is at least one of a mass of the book, a condition of the book, a title of the book, an edition of the book or an author of the book.

3. The apparatus of claim 1, wherein the computer processor is further configured to:
determine that the seller has accepted the offer;
transmit a confirmation of an acceptance of the offer to an electronic marketplace over a network;
cause transfer of a credit in the amount of the purchase price to the seller; and
cause a delivery of the book from the machine.

4. The apparatus of claim 1 further comprising a camera in communication with the computer processor,
wherein the camera is configured to capture an image of a surface of the book received in the chamber, and
wherein the computer processor is further configured to evaluate the captured image of the surface of the book to determine the attribute of the book.

5. A computer-implemented method for obtaining an item from a seller, the computer-implemented method comprising:
providing an apparatus comprising a computer processor and a chamber configured to receive the item from the seller;
receiving the item within the chamber;
determining, using the computer processor, at least one of an attribute of the item or identifying information regarding the item; and
determining, using the computer processor, a purchase price of the item based at least in part on the at least one of the attribute or the identifying information.

6. The computer-implemented method of claim 5, wherein the apparatus further comprises a display, and wherein the computer-implemented further comprises causing presentation on the display of the purchase price.

7. The computer-implemented method of claim 5, wherein the apparatus further comprises a camera, and wherein determining, using the computer processor, the at least one of the attribute of the item or the identifying information regarding the item comprises:
capturing an image of a surface of the item using the camera; and
evaluating the captured image of the surface to determine the at least one of the attribute of the item or the identifying information regarding the item.

8. The computer-implemented method of claim 7, wherein the surface of the item is an internal surface of the item.

9. The computer-implemented method of claim 7, wherein evaluating the captured image of the surface comprises:
comparing the captured image of the surface of the item to a baseline image of the item;
identifying a difference between the captured image of the surface of the item and the baseline image of the item; and
determining the at least one of the attribute of the item or the identifying information regarding the item based at least in part on the difference between the captured image of the surface of the item and the baseline image of the item.

10. The computer-implemented method of claim 7, wherein evaluating the captured image of the surface comprises:
transmitting the at least one captured image to an external service over a network; and
receiving the at least one of the attribute of the item or the identifying information regarding the item from the external service over the network.

11. The computer-implemented method of claim 5, wherein the apparatus further comprises an optical reader, and
wherein determining, using the computer processor, the at least one of the attribute of the item or the identifying information regarding the item comprises:
scanning a marking on the surface of the item using the at least one optical reader; and
interpreting the marking to determine at least one of the attribute of the item or the identifying information regarding the item using at least one computer processor.

12. The computer-implemented method of claim 5, wherein determining, using the computer processor, the purchase price for the item based at least in part on the at least one of the attribute or the identifying information comprises:
transmitting the at least one of the attribute or the identifying information to an external service over the network, and
receiving the purchase price from the external service over the network.

13. The computer-implemented method of claim 5, wherein the attribute of the item is a condition of the item, and
wherein determining, using the computer processor, the purchase price for the item comprises:
determining at least one of a projected demand for the item or a distribution strategy for the item based at least in part on the condition of the item; and
determining the purchase price of the item based at least in part on the at least one of the projected demand for the item or the distribution strategy.

14. The computer-implemented method of claim 5, further comprising:
initiating a purchase transaction for the item with the seller; and
causing a delivery of the item from the apparatus to facility associated with the electronic marketplace.

15. The computer-implemented method of claim 5, further comprising:
receiving authentication information regarding the seller; and
determining an identity of the seller based at least in part on the authentication information using the at least one computer processor.

16. An apparatus for automating a purchase of an item, the apparatus comprising:
a chamber configured to receive the item;
at least one of an optical scanning device, a camera or a mass measurement device;
a display configured to present information regarding the purchase of the item; and
a networked computer device in communication with the display and the at least one of the optical scanning device, camera or mass measurement device, the networked computer device configured to:
identify an attribute of the item received in the chamber based at least in part on information captured by the at least one of the optical scanning device, camera or mass measurement device,
identify the item received in the chamber based at least in part on the attribute, and
present, via the display, an offer to purchase the identified item received in the chamber.

17. The apparatus of claim 16, further comprising an individualized storage region and a conveying device configured to transport the item from the chamber to the individualized storage region.

18. The apparatus of claim 16, further comprising a packaging facility configured to package the item.

19. The apparatus of claim 16, further comprising an authentication device in communication with the networked computer device, wherein the authentication device is configured to authenticate the seller.

20. A non-transitory computer-readable medium having computer-executable instructions stored thereon, wherein the instructions, when executed, cause a computer system connected to a network and having at least one computer processor to perform a method comprising:
receiving information regarding an item deposited at an automated return machine;
confirming an identity of the item based at least in part on the information;
determining a condition of the item based at least in part on the information;
determining a level of demand for the item based at least in part on at least one of the identity of the item or the condition of the item;
generating an offer to purchase the item based at least in part on at least one of the identity of the item, the condition of the item or the level of demand for the item; and
causing a display of the offer to the seller on a display of the automated return machine.

21. The non-transitory computer-readable medium of claim 20, wherein the method further comprises:
determining a purchase price of the item based at least in part on at least one of the identity of the item, the condition of the item or the level of demand for the item,
wherein the offer comprises the purchase price.

22. The non-transitory computer-readable medium of claim 20, wherein the method further comprises:
receiving an acceptance of the offer via an input device of the automated return machine; and
causing remission of payment for the item at the purchase price.

23. The non-transitory computer-readable medium of claim 22, wherein the method further comprises causing an inventory level of the item at an electronic marketplace to be updated.

24. The non-transitory computer-readable medium of claim 20, wherein the information regarding the item deposited at the automated return machine comprises at least one of:
an image of the item;
a mass of the item;
a reading of an identifier on a surface of the item; or
a title of the item provided by the seller.
